(19) United States
(12) Patent Application Publication
(10) Pub. No.: US 2026/0279180 A1
(43) Pub. Date: Sep. 17, 2026

(54) HAZARD WARNING DEVICE FOR ROOFTOP PERIMETERS

(71) Applicants: Ricardo Menchaca, Upland, CA (US); Oswaldo Plascencia, Upland, CA (US); Gabriel Galvan, Fontana, CA (US)

(72) Inventors: Ricardo Menchaca, Upland, CA (US); Oswaldo Plascencia, Upland, CA (US); Gabriel Galvan, Fontana, CA (US)

(21) Appl. No.: 19/077,710

(22) Filed: Mar. 12, 2025

(51) Int. Cl. G08B 21/02

(52) U.S. Cl. CPC G08B 21/02

(57) ABSTRACT

A warning device for alerting individuals when the individuals enter a hazardous area includes a base and a post coupled to and extending upwardly from the base. A housing is coupled to a top end of the post and has a perimeter wall which extends from a lower end of the housing to an upper end of the housing. A processor is mounted in the housing and is operatively coupled to a sensing assembly and an alert assembly. The sensing assembly is mounted to the housing and is configured to remotely detect an object positioned in the hazardous area adjacent to the sensing assembly. The alert assembly is mounted to the housing. The processor is configured to cause the alert assembly to emit an alert when the sensing assembly detects the object positioned in the hazardous area.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### g) BACKGROUND OF THE INVENTION

### (1) Field of the Invention

The disclosure relates to hazard alert devices and more particularly pertains to a new hazard alert device for alerting individuals when the individuals enter a hazardous area.

### (2) Description of Related Art Including Information Disclosed Under 37 CFR 1.97 and 1.98

Various hazard alert devices which alert an individual when the individual passes a defined barrier into a region deemed to be hazardous to the individual are disclosed by the prior art. Many such devices comprise support structures for positioning sensing devices above a roof or other support surface and sensing, through an interruption of a light beam, pulling of a cable, or other means, an individual passing between two such support structures. Such devices typically follow this function with the emission of an alert signal as may be observed by the individual. However, the prior art fails to describe a device in which one support structures may be used to house sensing means for detecting the presence of an individual in one or more sensing regions extending away from the support structure. Such a device may be used tandem with, but independently from, other devices to cover various sections of a hazardous area without the need to run cables between support structures, align light beams, or other such tasks.

### (h) BRIEF SUMMARY OF THE INVENTION

An embodiment of the disclosure meets the needs presented above by generally comprising a base and a post coupled to and extending upwardly from the base. A housing is coupled to a top end of the post and has a perimeter wall which extends from a lower end of the housing to an upper end of the housing. A processor is mounted in the housing and is operatively coupled to a sensing assembly and an alert assembly. The sensing assembly is mounted to the housing and is configured to remotely detect an object positioned in the hazardous area adjacent to the sensing assembly. The alert assembly is mounted to the housing. The processor is configured to cause the alert assembly to emit an alert when the sensing assembly detects the object positioned in the hazardous area.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a warning device according to an embodiment of the disclosure.

FIG. 2 is a bottom perspective view of an embodiment of the disclosure.

FIG. 3 is a bottom view of an embodiment of the disclosure.

FIG. 4 is a top perspective exploded view of an embodiment of the disclosure.

FIG. 5 is a bottom perspective view of a housing of an embodiment of the disclosure.

FIG. 6 is a cross-sectional view of an embodiment of the disclosure taken from Line 6-6 in FIG. 4.

FIG. 7 is a cross-section view of an embodiment of the disclosure taken from Line 7-7 in FIG. 4.

FIG. 8 is a top perspective view of several electronic components of an embodiment of the disclosure.

FIG. 9 is a bottom perspective view of several electronic components of an embodiment of the disclosure.

FIG. 10 is an in-use view of an embodiment of the disclosure.

FIG. 11 is an in-use view of several devices according to an embodiment of the disclosure. The several devices as used together may also be considered another embodiment of the disclosure.

FIG. 12 is a block diagram of an embodiment of the disclosure.

### (j) DETAILED DESCRIPTION OF THE INVENTION

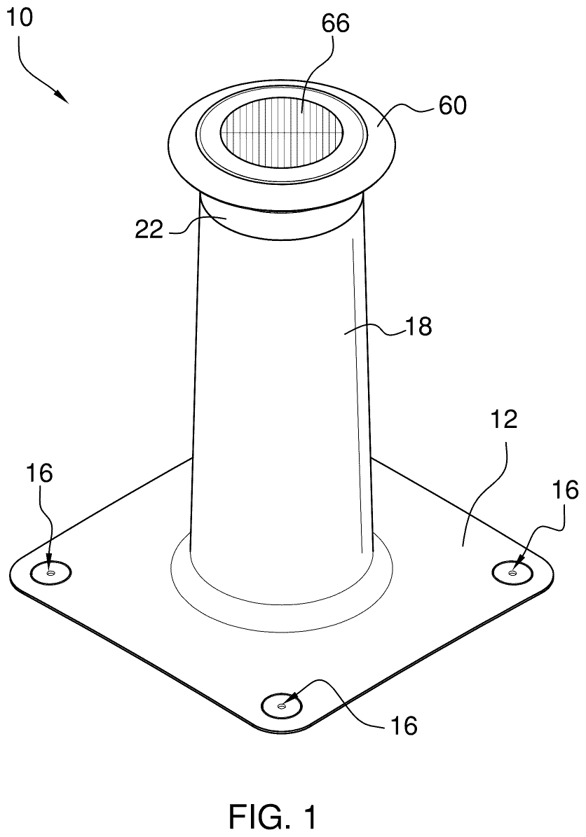

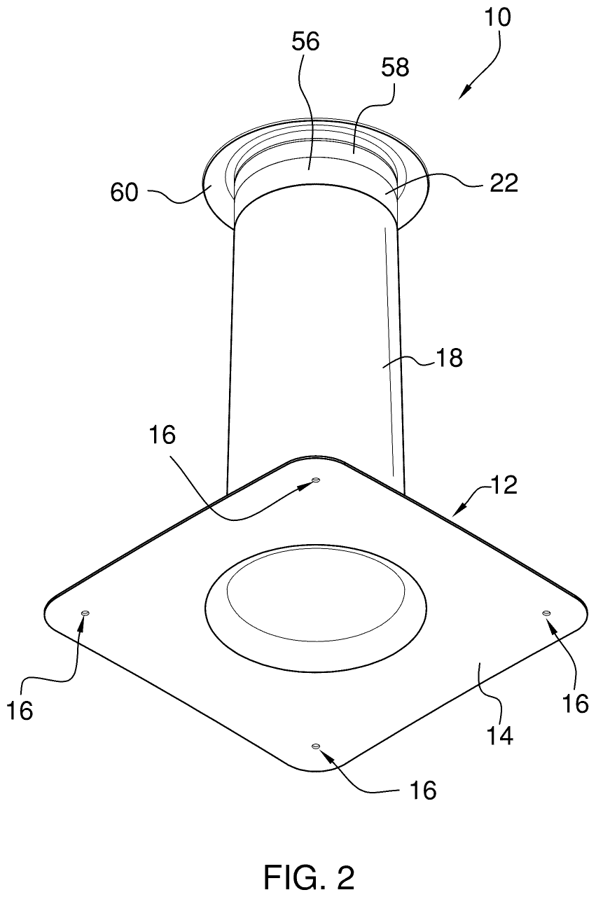

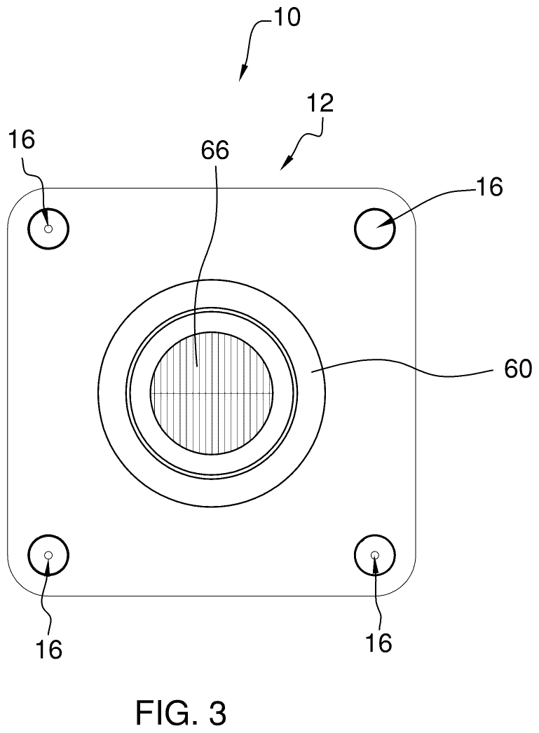

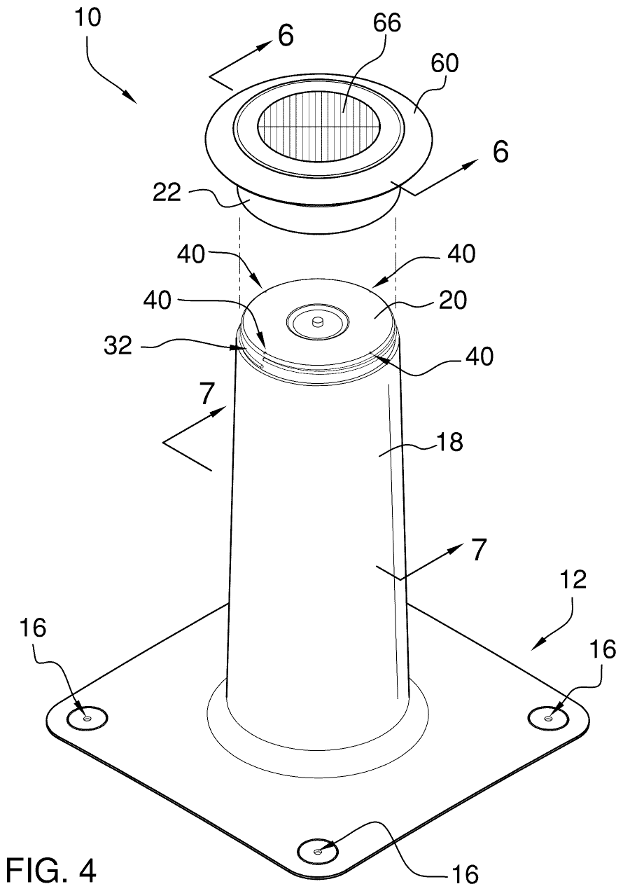

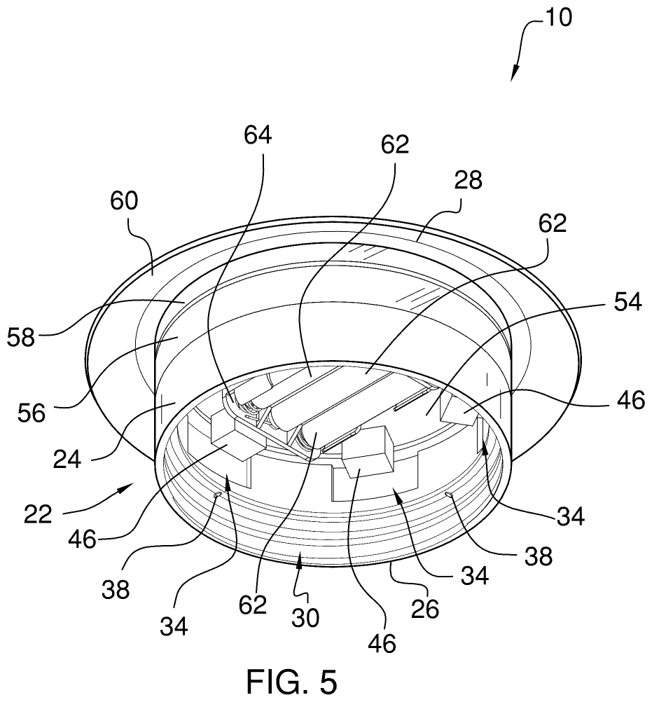

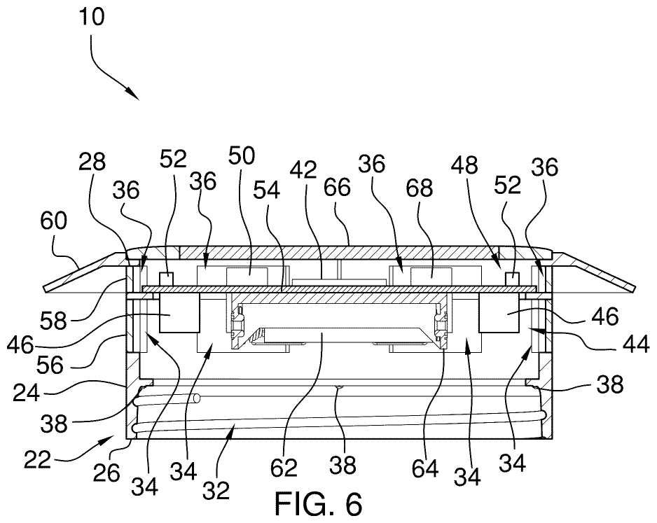

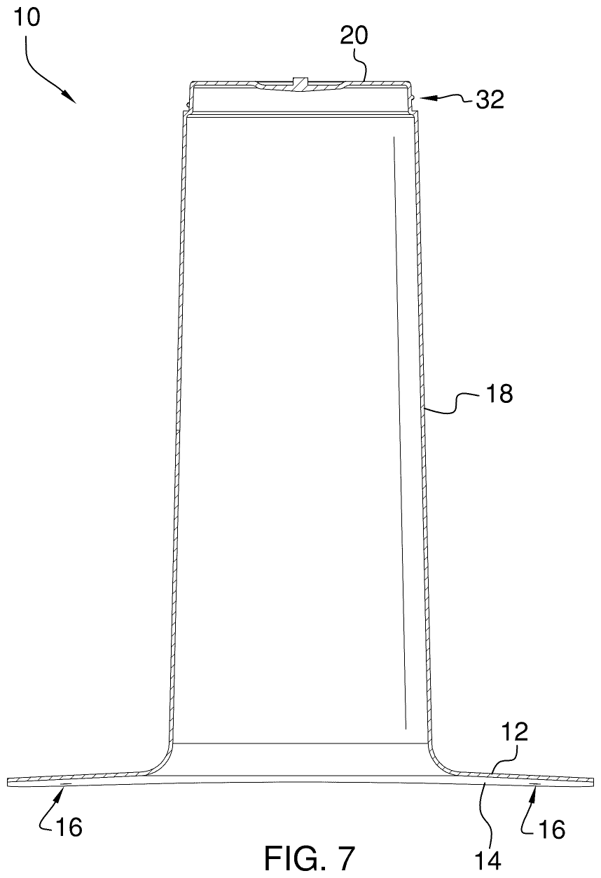

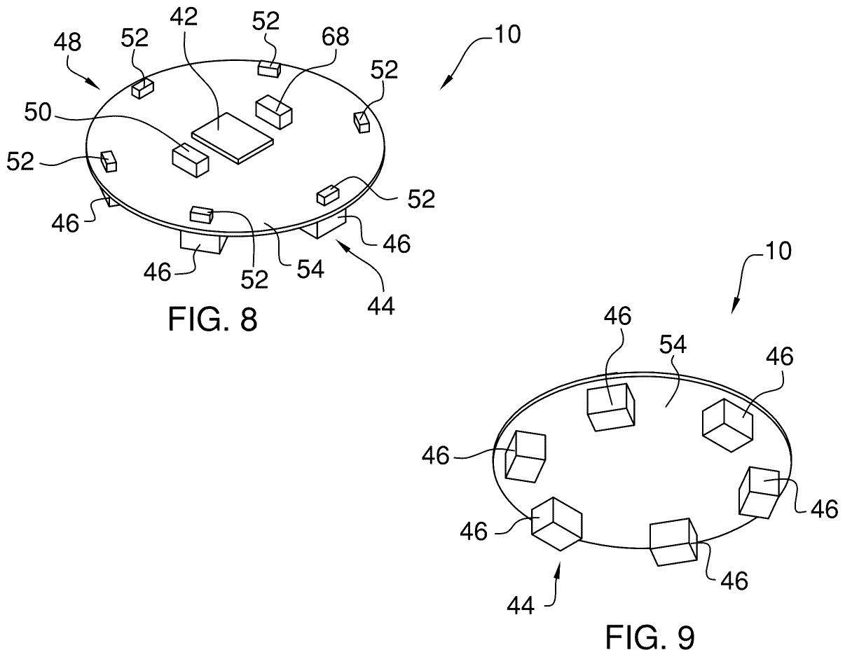

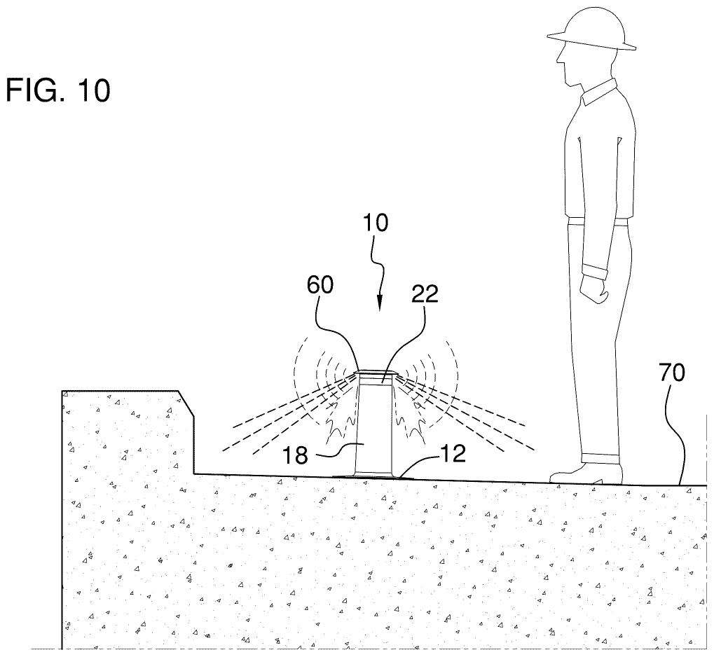

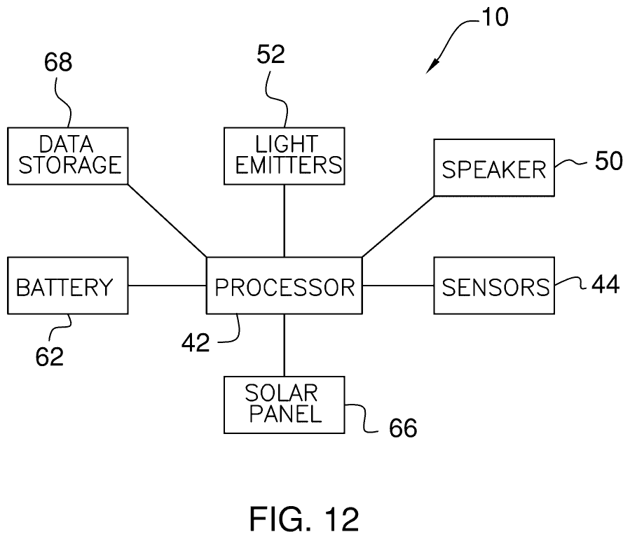

With reference now to the drawings, and in particular to FIGS. 1 through 12 thereof, a new hazard alert device embodying the principles and concepts of an embodiment of the disclosure and generally designated by the reference numeral 10 will be described.

As best illustrated in FIGS. 1 through 12, the warning device 10 generally comprises a base 12 and a post 18 coupled to and extending upwardly from the base 12. The base 12 has a generally planar bottom surface 14 such that the base 12 may be set atop a support surface 70 such as a roof of a building. The base 12 also has a plurality of mounting holes 16 which extends therethrough. Fasteners such as bolts, other threaded fasteners, concrete anchors, stakes, or the like may be received through the mounting holes 16 into the support surface 70 to secure the base 12 to the support surface 70. In other embodiments, other fastening devices may be used such as magnets, weights, clamps, or the like. The base 12 may differ in shape to conform to a shape of the support surface 70. The base 12 is integrally formed with the post 18 but may be formed separately.

A housing 22 is removably coupled to a top end 20 of the post 18. The housing 22 has a perimeter wall 24 which extends from a lower end 26 of the housing 22 to an upper end 28 of the housing 22. The perimeter wall 24 of the housing 22 has internal threads 30 which threadedly engage external threads 32 of the post 18 to mount the housing 22 to the post 18. Other fastening devices may be used to attach the housing 22 to the post 18 such as clamps, latches, snap-connection fasteners, magnets, locking pins or the like.

A securement assembly is provided for securing the housing 22 to the post 18 when the housing 22 is mounted to the post 18. The securement assembly comprises a plurality of detents 38 mounted to the housing 22, wherein each detent 38 of the plurality of detents 38 engages a respective recess 40 of a plurality of recesses 40 in the post 18 to secure the housing 22 to the post 18. The detents 38 secure the housing 22 to the post 18 until overcome by a sufficient force to urge balls of the detents 38 out of the respective recesses 40.

A processor 42 is mounted in the housing 22 and is operatively coupled to a sensing assembly 44 and an alert assembly 48. The processor 42, the sensing assembly 44, and the alert assembly 48 are mounted to a printed circuit board 54 which includes electric circuits for operatively coupling the components. In other embodiments, brackets or other structural components may hold the processor 42, the sensing assembly 44, and the alert assembly 48. The sensing assembly 44 is designed to detect when objects, including individuals, are positioned in a hazardous area 72 such as subregions of a perimeter region of a rooftop 76 of a building which are unprotected by handrails 78 or other sufficient barriers which would prevent individuals from falling off of the rooftop 76.

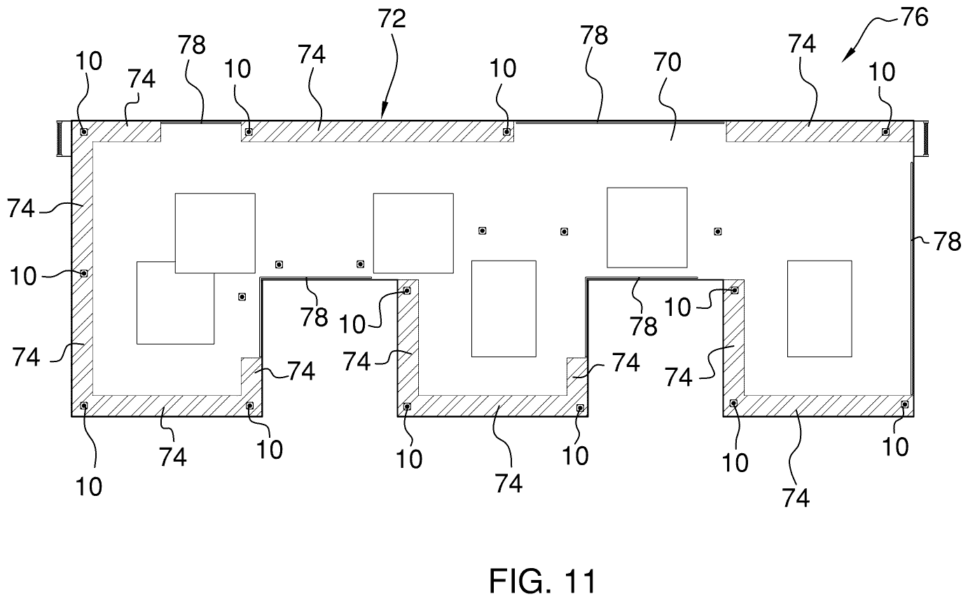

The hazardous area 72 may comprise several sensing regions 74, which are defined as used in the present disclosure to refer to sections of the hazardous area 72 which are observed by the sensing assemblies of one or more warning devices 10. The sensing regions 74 are therefore defined by placement and use of one or more warning devices 10. Each sensing region 74 extends away from at lease one warning device 10. With reference to FIG. 11, multiple warning devices 10 may be used to observe multiple sensing regions 74 of the hazardous area 72. The sensing regions 74 shown in FIG. 11 generally extend between adjacent warning devices 10 or outwardly from one warning device 10. In some cases, more than one warning device 10 may be used to observe the same sensing region 74, such as from opposite ends of the sensing region 74. The sensing assembly 44 comprises a plurality of sensors 46, each of which is configured to remotely detect objects when the objects are positioned in a respective sensing region 74 of the hazardous area 72 which extends outwardly with respect to the perimeter wall 24 of the housing 22 from the sensor 46. During installation and use, only a subset of the sensors 46 may be activated to search for objects. For example, sensors 46 positioned to face in opposite directions from each other may be activated when the warning device 10 is positioned to define two sensing regions 74 of the hazardous area 72 which extend in opposite directions from each other. In another example, sensors 46 positioned to face in directions set at a right angle from each other may be used in a portion of the hazardous area 72 that defines a ninety-degree corner, such that placement of one warning device 10 in the corner defines two sensing regions 74 which extend away from the one warning device 10 at a right angle to each other. The sensing assembly 44 may, in some embodiments, rely on a single sensor 46 which may be used to observe objects in one or more sensing regions 74 which extend away from the warning device 10. Such sensing regions 74 may be selected via suitable inputs during installation and use of the warning device 10.

The sensors 46 are equally radially spaced from each other with respect to a central axis of the housing 22 that extends between the lower end 26 and the upper end 28 of the housing 22. Each sensor 46 is positioned in the housing 22 and faces outwardly of the housing 22 through a respective sensor opening 34 of a plurality of sensor openings 34 which extends through the perimeter wall 24 of the housing 22. Each sensor 46 of the plurality of sensors 46 comprises a motion sensor.

A sensor window 56 is coupled to the perimeter wall 24 of the housing 22 and extends over the plurality of sensor openings 34 of the housing 22. The sensor window 56 protects the sensors 46 from debris while permitting a required energy transmission of the sensing assembly 44 through the sensor window 56. For example, if the sensors 46 transmit visible light for purposes of detecting objects in the sensing regions 74 of the hazardous area 72, the sensor window 56 is sufficiently transparent to facilitate such transmission of visible light. If the sensors 46 transmit infrared light or other forms of electromagnetic radiation, the sensor window 56 may comprise a material suitable for such transmission. The sensors 46 also may transmit ultrasonic waves or other suitable forms of energy for detection of objects in the hazardous area 72, and the sensor window 56 may comprise a material suitable for such transmission.

The processor 42 is configured to cause the alert assembly 48 to emit an alert when the sensing assembly 44 detects an object positioned in the hazardous area 72. The alert assembly 48 comprises a speaker 50 which is configured to emit an audible alarm when activated and a plurality of light emitters 52, each of which is configured to emit a visible alert when activated. The processor 42 may activate the speaker 50, one or more light emitters 52, or both the speaker 50 and one or more light emitters 52.

Each light emitter 52 is mounted adjacent to a respective sensor 46 of the plurality of sensors 46. Each light emitter 52 is configured to emit, when activated, the visible alert outwardly of the housing 22 through a respective light aperture 36 of a plurality of light apertures 36 which extends through the perimeter wall 24 of the housing 22. The visible alert may comprise a constantly emitting light, a strobe light, or any other suitable lighting pattern. The processor 42 is configured to activate each light emitter 52 of the plurality of light emitters 52 when the respective sensor 46 detects the object positioned in the hazardous area 72.

A light window 58 is coupled to the perimeter wall 24 of the housing 22 and extends over the plurality of light apertures 36 of the housing 22. The light window 58 comprises a transparent material such that visible light may be transmitted through the light window 58. A shroud 60 is coupled to the upper end 28 of the housing 22 and extends outwardly with respect to the perimeter wall 24 of the housing 22. The shroud 60 prevents obstruction to the sensors 46 and the light emitters 52 such as precipitation, sunlight, and the like.

Batteries 62 are mounted in a battery tray 64 that is attached to the printed circuit board 54. The batteries 62 power the processor 42 via an electrical coupling through the battery tray 64. A solar panel 66 is mounted atop the housing 22 and is electrically coupled to the batteries 62 via the processor 42 such that the solar panel 66 charges the batteries 62. Other power supplies may be used in other embodiments. For example, the processor 42 may be electrically couplable to a utility power supply via a suitable electrical plug.

A data storage 68 is operatively coupled to the processor 42 and is mounted to the printed circuit board 54. The processor 42 is configured to store data received from the sensing assembly 44. The data may be accessed via the processor 42 or other computers and analyzed such that information concerning instances wherein the sensing assembly 44 detects an object in the hazardous area 72 may be communicated to a user. Such information may include frequency of such detection instances, specific times at which detection instances occurred, and the like. The data storage 68 may be mounted in the post 18 and electrically coupled to the processor 42 via suitable electrical contacts between the housing 22 and the post 18. In other embodiments, wireless transmission via suitable transceivers may be used.

In use, one or more warning devices 10 may be placed in the hazardous area 72 to define one or more sensing regions 74. The sensing assemblies of each warning device 10 are set to observe such sensing regions 74 as further described above. When an object, including an individual, passes into one of the sensing regions 74, the sensor 46 observing the one sensing region 74 detects the object. The processor 42 then receives a signal from the sensor 46 observing the one sensing region 74 indicative of the detection of the object and causes the alert assembly 48 to emit the alert. The alert may include the audible alarm of the speaker 50, the visible alert of the light emitter 52 which corresponds to the sensor 46 observing the one sensing region 74, or both. Which form of alert is emitted may be selected via suitable inputs during installation of the warning device 10 or may be configured to depend on factors such as frequency with which the sensor 46 detects objects or duration of the presence of an object within the sensing region 74. The warning device 10 thereby warns an individual who enters the hazardous area 72 of their presence within such an area in an effort to direct the individual to leave the hazardous area 72 to avoid injury.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A warning device for alerting individuals when entering a hazardous area, the warning device comprising:
a base;
a post coupled to and extending upwardly from the base;
a housing coupled to a top end of the post, the housing having a perimeter wall which extends from a lower end of the housing to an upper end of the housing;
a processor mounted in the housing;
a sensing assembly operatively coupled to the processor and mounted to the housing, the sensing assembly being configured to remotely detect an object positioned in the hazardous area adjacent to the sensing assembly; and
an alert assembly operatively coupled to the processor and mounted to the housing, the processor being configured to cause the alert assembly to emit an alert when the sensing assembly detects the object positioned in the hazardous area.

2. The warning device of claim 1, wherein the sensing assembly comprises a plurality of sensors, each sensor of the plurality of sensors being configured to remotely detect the object when the object is positioned in a respective sensing region of the hazardous area which extends outwardly with respect to the perimeter wall of the housing from the sensor.

3. The warning device of claim 2, wherein the sensors of the plurality of sensors are radially spaced from each other with respect to a central axis of the housing extending between the lower end and the upper end of the housing.

4. The warning device of claim 2, wherein each sensor of the plurality of sensors is positioned in the housing and faces outwardly of the housing through a respective sensor opening of a plurality of sensor openings extending through the perimeter wall of the housing.

5. The warning device of claim 4, further comprising a sensor window coupled to the perimeter wall of the housing, the sensor window extending over the plurality of sensor openings of the housing, the sensor window being configured to permit a required energy transmission of the sensor assembly through the sensor window.

6. The warning device of claim 2, wherein each sensor of the plurality of sensors comprises a motion sensor.

7. The warning device of claim 1, wherein the alert assembly comprises a speaker, the speaker being configured to emit an audible alarm when activated.

8. The warning device of claim 1, wherein the alert assembly comprises a plurality of light emitters, each light emitter of the plurality of light emitters being oriented to emit, when activated, a visible alert in a direction from which the object was detected by the sensor assembly.

9. The warning device of claim 8, wherein:
the sensing assembly comprises a plurality of sensors, each sensor of the plurality of sensors being configured to remotely detect the object when the object is positioned in a respective sensing region of the hazardous area which extends outwardly with respect to the perimeter wall of the housing from the sensor; and
each light emitter of the plurality of light emitters is mounted adjacent to a respective sensor of the plurality of sensors, each light emitter of the plurality of light emitters being configured to emit, when activated, the visible alert outwardly of the housing through a respective light aperture of a plurality of light apertures extending through the perimeter wall of the housing, the processor being configured to activate each light emitter of the plurality of light emitters when the respective sensor detects the object positioned in the hazardous area.

10. The warning device of claim 9, further comprising a light window coupled to the perimeter wall of the housing, the light window extending over the plurality of light apertures of the housing, the light window comprising a transparent material such that visible light may be transmitted through the light window.

11. The warning device of claim 1, wherein the base has a plurality of mounting holes extending therethrough, the base being configured to mount to a support surface via fasteners inserted through the plurality of mounting holes into the support surface.

12. The warning device of claim 1, wherein the housing is removable from the post.

13. The warning device of claim 12, wherein the perimeter wall of the housing has internal threads which threadedly engage external threads of the post.

14. The warning device of claim 13, further comprising a securement assembly for securing the housing to the post, the securement assembly comprising a plurality of detents mounted to the housing, each detent of the plurality of detents engaging a respective recess of a plurality of recesses in the post to secure the housing to the post.

15. The warning device of claim 1, further comprising a shroud coupled to the upper end of the housing, the shroud extending outwardly with respect to the perimeter wall of the housing.

16. The warning device of claim 1 further comprising a power supply electrically coupled to the processor, the power supply comprising a battery.

17. The warning device of claim 16, further comprising a solar panel mounted atop the housing and electrically coupled to the power supply.

18. The warning device of claim 1, further comprising a data storage operatively coupled to the processor, the processor being configured to store data received from the sensor assembly.

19. A warning device for alerting individuals when entering a hazardous area, the warning device comprising:
a base, the base having a plurality of mounting holes extending therethrough, the base being configured to mount to a support surface via fasteners inserted through the plurality of mounting holes into the support surface;
a post coupled to and extending upwardly from the base;
a housing coupled to a top end of the post, the housing having a perimeter wall which extends from a lower end of the housing to an upper end of the housing, the housing being removable from the post, the perimeter wall of the housing having internal threads which threadedly engage external threads of the post;
a processor mounted in the housing;
a sensing assembly operatively coupled to the processor and mounted to the housing, the sensing assembly comprising a plurality of sensors, each sensor of the plurality of sensors being configured to remotely detect an object when the object is positioned in a respective sensing region of the hazardous area which extends outwardly with respect to the perimeter wall of the housing from the sensor, the plurality of sensors being radially spaced from each other with respect to a central axis of the housing extending between the lower end and the upper end of the housing, each sensor of the plurality of sensors being positioned in the housing and facing outwardly of the housing through a respective sensor opening of a plurality of sensor openings extending through the perimeter wall of the housing, each sensor of the plurality of sensors comprising a motion sensor;
an alert assembly operatively coupled to the processor and mounted to the housing, the processor being configured to cause the alert assembly to emit an alert when the sensing assembly detects the object positioned in the hazardous area, the alert assembly comprising:
a speaker, the speaker being configured to emit an audible alarm when activated; and
a plurality of light emitters, each light emitter of the plurality of light emitters being mounted adjacent to a respective sensor of the plurality of sensors, each light emitter of the plurality of light emitters being configured to emit, when activated, a visible alert outwardly of the housing through a respective light aperture of a plurality of light apertures extending through the perimeter wall of the housing, the processor being configured to activate each light emitter of the plurality of light emitters when the respective sensor detects the object positioned in the hazardous area;
a sensor window coupled to the perimeter wall of the housing, the sensor window extending over the plurality of sensor openings of the housing, the sensor window being configured to permit a required energy transmission of the sensor assembly through the sensor window;
a light window coupled to the perimeter wall of the housing, the light window extending over the plurality of light apertures of the housing, the light window comprising a transparent material such that visible light may be transmitted through the light window;
a securement assembly for securing the housing to the post, the securement assembly comprising a plurality of detents mounted to the housing, each detent of the plurality of detents engaging a respective recess of a plurality of recesses in the post to secure the housing to the post;
a shroud coupled to the upper end of the housing, the shroud extending outwardly with respect to the perimeter wall of the housing;
a power supply electrically coupled to the processor, the power supply comprising a battery;
a solar panel mounted atop the housing and electrically coupled to the power supply; and
a data storage operatively coupled to the processor, the processor being configured to store data received from the sensor assembly.
